(19) United States
(12) Patent Application Publication
(10) Pub. No.: US 2008/0231585 A1
(43) Pub. Date: Sep. 25, 2008

(54) DISPLAY APPARATUS OF DYNAMIC IMAGE AND DISPLAY METHOD THEREOF

(75) Inventors: Chih-Liang Wu, Chiayi County (TW); Tien-Chu Hsu, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/840,991

(22) Filed: Aug. 19, 2007

(30) Foreign Application Priority Data
Mar. 23, 2007 (TW) 96110075

(51) Int. Cl. H04N 5/235

(52) U.S. Cl. 345/99; 348/E03.019

(57) ABSTRACT

A display apparatus of a dynamic image and a display method thereof are provided. The display method includes the following steps. An image signal is received and then displayed through either a black insertion (BI) technology or a dynamic backlight luminance (DBL) technology according to image luminance. The image signal is displayed through the BI technology when the image signal is in a bright state and through the DBL technology when the image signal is in a dark state, so as to prevent a zebra effect from being exerted by employing both technologies simultaneously.

### CROSS-REFERENCE TO RELATED APPLICATION

This application claims the priority benefit of Taiwan application serial no. 96110075, filed Mar. 23, 2007. All disclosure of the Taiwan application is incorporated herein by reference.

### BACKGROUND OF THE INVENTION

1. Field of the Invention

The present invention relates to a method for enhancing a dynamic image, and more particularly to a display method for enhancing a dynamic image through a black insertion (BI) technology and a dynamic backlight luminance (DBL) technology.

2. Description of Related Art

Thin-film transistor liquid crystal displays (TFT-LCDs) used to be default monitors of notebook (NB) computers or of personal computers. Therefore, most image signals of the TFT-LCDs are static images in most cases. However, in recent years, liquid crystal displaying technology has been gradually adopted in large-sized TFT-LCDs thanks to continuous research and development made by various manufacturers. Moreover, the static image signals have become dynamic image signals. Nowadays, the TFT-LCD utilizes a hold-type display of which a pixel holds a brightness of the present image until a subsequent image signal is inputted to a pixel. Thus, the hold-type display may lead to some motion blurs of the dynamic images.

To improve display quality of the dynamic images, a black insertion (BI) technology and a dynamic backlight luminance (DBL) technology are often employed at this current stage. The BI technology removes eye-trace integration effect by displaying black images, while the DBL technology adjusts luminance of a backlight source to improve image contrast. However, due to the technical properties of the two technologies, a zebra effect may be generated when the BI technology and the DBL technology are directly adopted together. Please refer to FIG. 1 which illustrates the zebra effect arisen from the BI technology and the DBL technology according to the related art.

The DBL technology mainly adopts a digital dimming in which the backlight is alternatively switched to an on state or an off state rapidly to change the backlight luminance through regulating the duty cycle. As the black insertion and the backlight are both in the on state at a same time, the inserted black frame stands out because of the on-state backlight. By contrast, the inserted black frame is not pronounced enough when the backlight is in the off state. In other words, the inserted black images achieve different performance when the backlight is on or off, resulting in the zebra effect. During the same frame time, the number of the image stripes caused by the zebra effect is determined by the times for which the backlight is in the on state, while the width of the image strips is decided by the period during which the backlight is in the on state. As the backlight is on for a longer period of time, the image strips become wider.

### SUMMARY OF THE INVENTION

The present invention is directed to a display method of a dynamic image and a display apparatus thereof. Here, a BI technology and a DBL technology are combined, and the application of either the BI technology or the DBL technology is determined based on image luminance, preventing a zebra effect from being acquired by employing both technologies simultaneously.

The present invention is further directed to a display method of a dynamic image and a display apparatus thereof. Through alternatively employing a BI technology and a DBL technology to enhance the dynamic image, a zebra effect arisen from simultaneously employing the BI technology and the DBL technology is avoided.

The present invention provides a display method of a dynamic image. The display method includes first receiving an image signal and then displaying the image signal through performing either a BI technology or a DBL technology.

According to an embodiment of the present invention, the display method further includes determining luminance of the image signal which is displayed through adopting the BI technology when the image signal is in a bright state and through adopting the DBL technology when the image signal is in a dark state.

According to an embodiment of the present invention, the BI technology and the DBL technology are disabled when the image signal is in a intermediary state.

According to an embodiment of the present invention, a gray scale value of the image signal is X in the display method. X ranges from 0 to 255. The image signal is a black signal (full black) when X equals 0. The image signal is a white signal (full white) when X equals 255. The image signal is in the intermediary state when 65≦X≦85.

According to an embodiment of the present invention, the image signal is in the dark state when 0≦X<65, while the image signal is in the bright state when 85<X≦255.

According to an embodiment of the present invention, the step of determining luminance of the image signal further includes determining luminance of the image signal based on an average gray scale value of the image signal.

According to an embodiment of the present invention, the step of displaying the image signal through adopting either the BI technology or the DBL technology further includes sequentially displaying a first image and a second image, displaying the first image with use of the BI technology, and displaying the second image with use of the DBL technology.

The present invention further provides a display apparatus including a timing controller, a backlight controller, and a determining unit. The timing controller provides a BI function, the backlight controller supplies a DBL function, and the determining unit is used for determining luminance of an image signal. Here, the BI function of the timing controller is enabled when the image signal is in a bright state, and the DBL function of the backlight controller is enabled when the image signal is in a dark state.

According to an embodiment of the present invention, the BI function and the DBL function are disabled when the image signal is in a intermediary state.

In view of the foregoing, a proper timing for employing the BI technology or the DBL technology is determined based on the image luminance. As the image is relatively dark, the DBL technology is conducted to display the color of black in a greater darkness. As the image is comparatively bright, the BI technology is adopted to reduce the moving picture response time (MPRT) to improve the quality of the moving pictures. Furthermore, the present invention further provides the display method for displaying the images through alternatively employing the BI technology and the DBL technology, which avoids the zebra effect arisen from utilizing both technologies simultaneously.

In order to make the aforementioned and other objects, features and advantages of the present invention more comprehensible, several embodiments accompanied with figures are described in detail below.

### BRIEF DESCRIPTION OF THE DRAWINGS

FIG. 1 illustrates a zebra effect according to the related art.

FIG. 2 is a block view illustrating a display apparatus according to an embodiment of the present invention.

FIG. 3 is a schematic view illustrating average image brightness according to the present invention.

FIG. 4 is a schematic view illustrating a display method according to another embodiment of the present invention.

FIG. 5 is a flow chart illustrating a driving method according to another embodiment of the present invention.

FIG. 6 is a flow chart illustrating the driving method depicted in FIG. 5.

FIG. 7 is a flow chart illustrating the driving method depicted in FIG. 5.

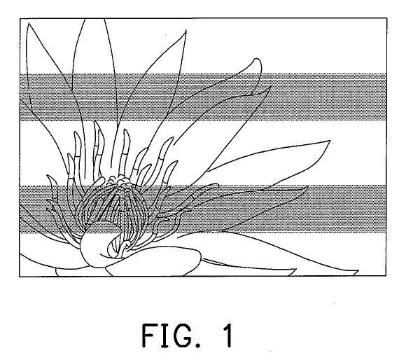

### DESCRIPTION OF EMBODIMENTS

A BI technology is mainly applied to reduce an MPRT and improve the quality of dynamic images. Particularly, the BI effect can be further manifested as the dynamic images are in a bright state, while the BI effect is impaired when the dynamic images are in a dark state. On the other hand, the DBL technology is mainly conducted to display the color of black in a greater darkness, but does not accomplish any special effect as the dynamic images are in the bright state. In the present embodiment, the above difference can be utilized to determine a timing at which the BI technology or the DBL technology is adopted at a time (or in the same fame), such that the panel may be equipped with the BI function and the DBL function without inducing a zebra effect.

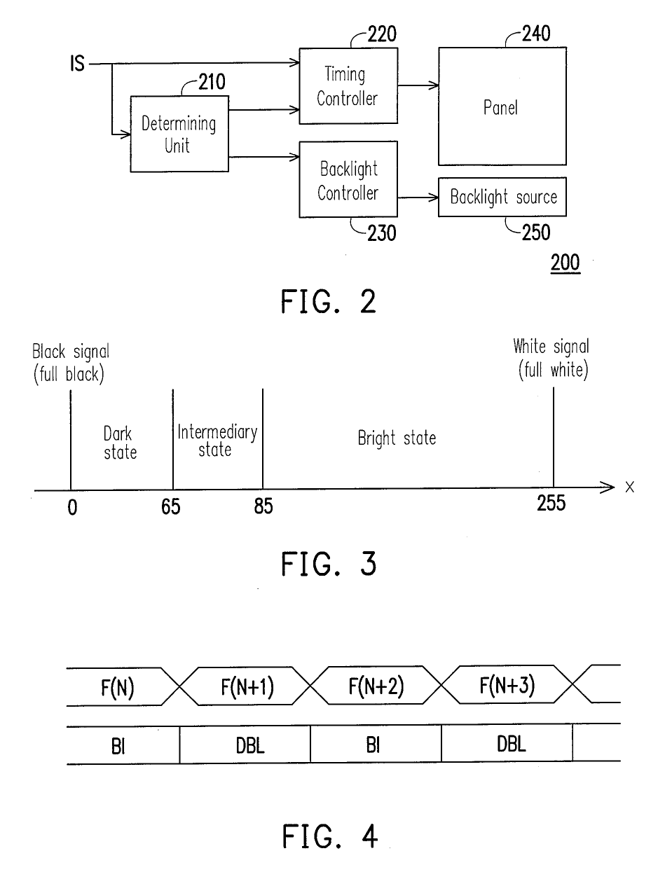

FIG. 2 is a block view illustrating a display apparatus according to an embodiment of the present invention. A display apparatus 200 includes a determining unit 210, a timing controller 220, a backlight controller 230, a panel 240 and a backlight source 250. The timing controller 220 provides a BI function, the backlight controller 230 supplies a DBL function, and the determining unit 210 is used for determining luminance of an image signal IS. The determining unit 210 enables the BI function of the timing controller 220 when the image signal IS is in a bright state, and the DBL function of the backlight controller 230 is enabled when the image signal IS is in a dark state.

In other words, the display apparatus 200 determines that either the BI function or the DBL function is applied to improve the display effect of the dynamic image based on luminance of the image signal IS. In the present embodiment, the average image brightness is classified into three states i.e. a bright state, a dark state and a intermediary state. The BI technology is adopted as the image is in the bright state, the DBL technology is applied when the image is in the dark state, and neither the BI technology nor the DBL technology is employed while the image is in the intermediary state.

The image luminance is determined as illustrated in FIG. 3. FIG. 3 is a schematic view illustrating average image brightness according to the present invention. In the present embodiment, a gray scale value X of the image signal ranges from 0 to 255. The image signal IS is a black signal (full black) when X equals 0, and the image signal IS is a white signal (full white) when X equals 255. The image signal IS is in the intermediary state when 65≦X≦85, the image signal IS is in the dark state when 0≦X<65, and the image signal IS is in the bright state when 85<X≦255. The so-called bright state denotes that the image signal IS corresponds to the image (frame) with higher average brightness, and the dark state refers to the image (frame) with lower average brightness. The gray scale value may be determined based on display specifications, using environment, and the BI technology or the DBL technology which is utilized, and is not limited in the present embodiment.

According to another embodiment, to prevent the zebra effect arisen from simultaneously employing the BI function and the DBL function, the present invention provides a display method alternatively adopting two technologies, as shown in FIG. 4. FIG. 4 is a schematic view illustrating a display method according to another embodiment of the present invention. In the present embodiment, the BI technology and the DBL technology are alternatively employed in consecutive frames F(N)˜F(N+3). For example, the BI technology is adopted in the frame F(N), while the DBL technology is employed in the next frame F(N+1). By alternatively using said two technologies, the dynamic image can be improved. Since the display apparatus merely adopts either the BI technology or the DBL technology at the same frame time (the time at which the frame is displayed), no zebra effect may occur.

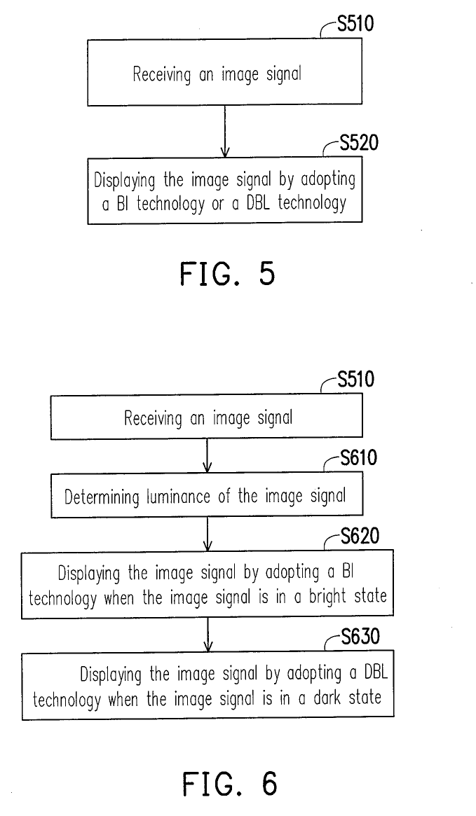

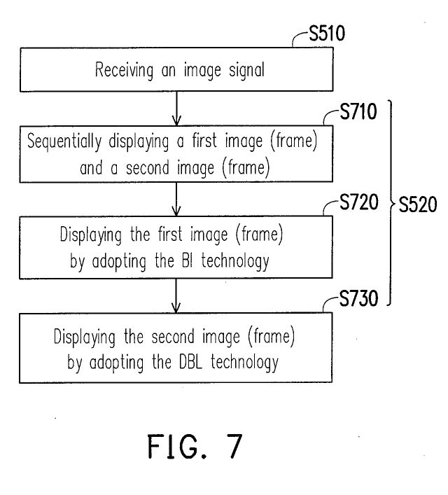

From another perspective, the operating method of the display apparatus may be referred to as a driving method, and a flow chart is provided hereinafter for further explanation. FIG. 5 is a flow chart illustrating a driving method according to another embodiment of the present invention. In step S510, one image signal is received. Then, in step S520, either the BI technology or the DBL technology is adopted to display the image signal. Step S520 can be further exemplified by two following embodiments depicted in FIGS. 6 and 7, respectively.

FIG. 6 is a flow chart illustrating the driving method depicted in FIG. 5. As illustrated in FIG. 6, step S520 includes steps S610˜S630. In step S610, luminance of the image signal is determined. (Please refer to the description of FIG. 3). After that, in step S620, the image signal is displayed through the BI technology when the image signal is in the bright state, and the image signal is displayed through the DBL technology when the image signal is in the dark state, as shown in step S630.

FIG. 7 is a flow chart illustrating the driving method depicted in FIG. 5. As shown in FIG. 6, step S520 includes steps S710˜S730. In step S710, a first image (frame) and a second image (frame) are sequentially displayed. Here, the first and the second images (frames) correspond to the image signals received thereby, respectively. Thereafter, in step S720, the BI technology is adopted to display the first image (frame), while the DBL technology is applied to display the second image (frame) in step S730. (Please refer to the description of FIG. 4.)

Based on the above, the present invention combines the BI technology and the DBL technology according to the above embodiments to determine either the BI technology or the DBL technology is adopted based on image luminance, preventing the zebra effect from being exerted by employing both technologies simultaneously. Besides, the present invention further provides a driving method alternatively adopting the BI technology or the DBL technology. As the dynamic image is in the bright state, the image retention phenomenon is reduced, and the color of black in the images is in a greater darkness when the dynamic image is in the dark state. Likewise, the zebra effect can be avoided.

Although the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A display method, comprising:
receiving an image signal; and
displaying the image signal through either a black insertion (BI) technology or a dynamic backlight luminance (DBL) technology.

2. The display method of claim 1, wherein the step of displaying the image signal through either the BI technology or the DBL technology further comprises:
determining luminance of the image signal;
displaying the image signal through the BI technology when the image signal is in a bright state; and
displaying the image signal through the DBL technology when the image signal is in a dark state.

3. The display method of claim 2, wherein the BI technology and the DBL technology are disabled when the image signal is in a intermediary state.

4. The display method of claim 3, wherein a gray scale value X of the image signal ranges from 0 to 255, the image signal being a black signal when X equals 0, the image signal being a white signal when X equals 255, the image signal being in the intermediary state when 65≦X≦85.

5. The display method of claim 2, wherein a gray scale value X of the image signal ranges from 0 to 255, the image signal being a black signal when X equals 0, the image signal being a white signal when X equals 255, the image signal being in the dark state when 0≦X<65, the image signal being in the bright state when 85<X≦255.

6. The display method of claim 2, wherein the step of determining luminance of the image signal further comprises determining luminance of the image signal based on an average gray scale value of the image signal.

7. The display method of claim 1, wherein the step of displaying the image signal through either the BI technology or the DBL technology further comprises:
sequentially displaying a first frame and a second frame;
displaying the first frame through the BI technology; and
displaying the second frame through the DBL technology.

8. A display apparatus, comprising:
a timing controller providing a BI function;
a backlight controller providing a DBL function; and
a determining unit for determining luminance of an image signal,
wherein the BI function of the timing controller is enabled when the image signal is in a bright state, and the DBL function of the backlight controller is enabled when the image signal is in a dark state.

9. The display apparatus of claim 8, wherein the BI function and the DBL function are disabled when the image signal is in a intermediary state.

10. The display apparatus of claim 8, wherein a gray scale value X of the image signal ranges from 0 to 255, the image signal being a black signal when X equals 0, the image signal being a white signal when X equals 255, the image signal being in a intermediary state when 65≦X≦85.

11. The display apparatus of claim 8, wherein a gray scale value X of the image signal ranges from 0 to 255, the image signal being a black signal when X equals 0, the image signal being a white signal when X equals 255, the image signal being in the dark state when 0≦X<65, the image signal being in the bright state when 85<X≦255.

12. The display apparatus of claim 8, further comprising:
a panel for displaying the image signal; and
a backlight source which is controlled by the backlight controller and used for providing a backlight to the panel.
